(19) United States
(12) Patent Application Publication
(10) Pub. No.: US 2009/0145888 A1
(43) Pub. Date: Jun. 11, 2009

(54) PREPARING AND PERFORMING OF A LASER WELDING PROCESS

(75) Inventors: Tim Hesse, Ditzingen (DE); Dieter Pfitzner, Weil der Stadt (DE); Winfried Magg, Ditzingen (DE)

Correspondence Address: FISH & RICHARDSON PC, P.O. BOX 1022, MINNEAPOLIS, MN, 55440-1022, US

(73) Assignee: TRUMPF WERKZEUGMASCHINEN GMBH + CO. KG, Ditzingen (DE)

(21) Appl. No.: 12/274,160

(22) Filed: Nov. 19, 2008

(30) Foreign Application Priority Data
Nov. 20, 2007 (EP) 07022462.4-1262

(51) Int. Cl. B23K 26/00

(52) U.S. Cl. 219/121.64; 219/121.63

(57) ABSTRACT

A first position of a joint site on a workpiece is detected with a sensor device. The first position is in a first measurement zone in front of a laser beam incident on the workpiece. The second position is in a second measurement zone at the position of the laser beam, and the third position is in a third measurement zone behind the position of the laser beam. One or more of a second position and a third position of the joint site is detected. The position of the laser beam incident on the workpiece is detected. The first, and one or more of the second and third positions are compared to the position of the laser beam, and, based on the comparison, one or more of a laser machining head configured to direct the laser beam onto the workpiece and the sensor device are adjusted relative to the workpiece.

### CROSS-REFERENCE TO RELATED APPLICATION

This application claims priority under 35 U.S.C. § 119(a) to European Patent Application No. 07 022 462.4, filed on Nov. 20, 2007, the entire contents of which is hereby incorporated by reference.

### TECHNICAL FIELD

The present disclosure relates to preparing a laser welding process on a workpiece and to techniques for performing the laser welding process on a workpiece.

### BACKGROUND

In laser welding, the precise alignment of the laser beam to the joint gap or joint site effects the quality of the weld seam formed during the welding process. For example, when welding different materials such as steel and cast steel in butt joints, for metallurgical reasons the laser beam is positioned precisely in the area of the joint with a precision within, for example, hundreds of millimeters.

### SUMMARY

In one general aspect, techniques for preparing or performing a laser welding process that allows seam position control, in particular with compensation of drift movements of the laser beam in the machining optical system is discussed.

In one general aspect, a method for preparing for laser welding of a workpiece includes detecting, with a sensor device, a first position of a joint site on a workpiece. The first position is in a first measurement zone in front of a position of a laser beam incident on the workpiece. With the sensor device, one or more of a second position and a third position of the joint site is detected, the second position is in a second measurement zone at the position of the laser beam incident on the workpiece, and the third position is in a third measurement zone behind the position of the laser beam incident on the workpiece. The position of the laser beam incident on the workpiece is detected with the sensor device. The first, and one or more of the second and third positions of the joint site are compared to the position of the laser beam, and, based on the comparison, one or more of a laser machining head configured to direct the laser beam onto the workpiece and the sensor device are adjusted relative to the workpiece.

Implementations can include one or more of the following features. The laser machining head can be adjusted, and adjusting the laser machining head can include one or more of adjusting a position and alignment of the laser machining head relative to the workpiece. The sensor device is adjusted, and adjusting the sensor device can include one or more of adjusting a position, alignment, and coordinate system of the sensor device. Adjusting one or more of a laser machining head and the sensor device can include, while detecting the positions of the joint site on the workpiece, moving the laser machining head and the workpiece relative to each other along the joint site.

In some implementations, at least one light line can be projected into a measurement zone on the workpiece, and a reflection of the at least one light line can be detected using the detected reflection. Projecting at least one light line onto the workpiece can include projecting two or more light lines onto the workpiece, an alignment of the light lines in the first and third measurement zones can be determined, and the laser machining head can be aligned with the workpiece based on the alignment of the light lines in the first and third measurement zones. Determining an alignment of the light lines in the first and third measurement zones can include determining whether the light lines in the first and third measurement zones are parallel to each other. In some implementations, the light lines are parallel to each other, and a distance of the laser machining head from the workpiece can be determined from the position of two parallel aligned light lines in the first and third measurement zones. The distance of the laser machining head from the workpiece can be set to a nominal distance.

In yet other implementations, detecting the position of the laser beam incident on the workpiece can include detecting a position of a test point marked on the workpiece by the laser beam and can include adapting the coordinate system of the sensor device to the detected position of the test point. Adapting the coordinate system of the sensor device can include shifting the sensor device or the measurement zones until the position of the test point is at a nominal position. The nominal position can be a center of the second measurement zone. A coordinate system of the sensor device can be adapted to a course of the joint site by moving the first and third measurement zones relative to each other. The position of the laser beam can be in the center of the second measurement zone, and the first and third measurement zones can be moved until the joint site is positioned centrally in the first and third measurement zones.

In another general aspect, a method for performing laser welding on a workpiece includes detecting, with a sensor device prior to laser welding, a first position of a joint site on a workpiece, the first position being in a first measurement zone in front of a position of a laser beam incident on the workpiece, and detecting, with the sensor device prior to laser welding, one or more of a second position and a third position of the joint site. The second position is in a second measurement zone at the position of the laser beam incident on the workpiece, and the third position is in a third measurement zone behind the position of the laser beam incident on the workpiece. Prior to laser welding and with the sensor device, the position of the laser beam incident on the workpiece is detected. The first, and one or more of the second and third positions of the joint site are compared to the position of the laser beam, and prior to welding and based on the comparison, one or more of a laser machining head configured to direct the laser beam onto the workpiece and the sensor device are adjusted relative to the workpiece. During laser welding, a position of a joint site on the workpiece in a first measurement zone in front of a position of the laser beam is detected, and the position of the laser beam in a second measurement zone at a focus area of the laser beam is detected. An optimum weld position is determined by comparing the detected position of the laser beam and the detected position of the joint site, and the laser machining head is moved to the optimum weld position.

Implementations can include one or more of the following features. The laser machining head can be moved along the joint site by a guide device. Prior to the laser welding of the workpiece, a deviation of the position of the joint site in a second measurement zone at the position of the laser beam from the position of the laser beam can be determined. Determining the optimal weld position can include compensating for the deviation.

In yet another general aspect, an apparatus for laser welding includes a laser machining head, a lens, a sensor device, and an analysis device. The laser machining head is configured to direct a laser beam onto a workpiece. The lens is configured to focus the laser beam onto the workpiece such that the workpiece is welded at a focus area of the laser beam, and the sensor device includes a sensor configured to image a first measurement zone in front of the focus area, a second measurement zone at the focus area, and a third measurement zone behind the focus area. The analysis device is configured to determine a first position of a joint site on the workpiece in the first measurement zone and a second position of the joint site in the second measurement zone, and a third position of the joint site in the third measurement zone. The analysis device is also configured to determine a position of the focus area of the laser beam, compare the first, second and third positions of the joint site and the position of the focus area of the laser beam, and adjust one or more of the laser machining head and the sensor device relative to the workpiece based on the comparison.

Implementations can include one or more of the following features. The apparatus can include at least one light projector configured to direct a light line onto the workpiece. The apparatus can include a deflection mirror configured to deflect radiation from the workpiece onto the sensor. The sensor can include a CMOS camera. The apparatus can include a guide device coupled to the laser machining head, and the guide device can be configured to move the laser machining head. The guide device can include a robotic arm.

Optical seam tracking sensors can be used during the welding process to determine the position of the joint ahead of the welding point in order to compensate for tolerances of the workpiece and the clamping device. Previous seam tracking sensors were typically set up manually. For example, a low power laser beam can be generated at a test point or linear engraving on a test workpiece and, subsequently, a measurement of the systematic offset of the seam tracking sensor based on the deviation between the test point or engraving and the joint site can be made manually. The offset dimension is taken into account in calibrating the sensor. However, the test point or engraving is typically generated with low laser power, and, as a result, a beam offset can occur when welding with high power. Another possibility for adjusting the seam tracking sensor is destructive testing of the welded components. For example, by analyzing a ground section of the weld seam, the seam position is assessed and a sensor offset adjusted accordingly. However, these two techniques can be time-intensive and relatively inaccurate. Additionally, the achievable accuracy depends on the skill of the machine operator and the measurement devices available.

Furthermore, conventional seam tracking sensors can provoke lateral shifts in the joint site after the sensor, caused for example by torsion of the workpiece. Such sensors generally cannot detect lateral drift movements of the laser beam during laser machining. Drift movements of the laser beam, caused, for example, by thermally induced changes or soiling of the optical components in the beam path, can lead to incorrect positioning of the weld seam.

Preparing for a laser welding process includes detection, using a sensor device, of a position of a joint site on a workpiece in a first measurement zone in front of the laser beam position, detection of the position of the joint site in a second measurement zone at the laser beam position and/or in a third measurement zone after the laser beam position with the sensor device, and detection of the laser beam position in the second measurement zone with the sensor device. The positions of the joint site in the respective measurement zones and the position of the laser beam are compared in order to adapt the position and/or alignment and/or coordinate system of the sensor device and/or a laser machining head relative to the workpiece.

The techniques discussed below include detecting the position of the joint, in particular a joint gap, not only ahead of the laser beam position that corresponds to the weld site in the welding process, but also at and/or after the laser beam position. Typically, position detection of the joint site during the welding process is challenging or impossible because of the process light that occurs during the welding process in the area of the weld site. Also, in the region after the weld site, only the weld seam formed during welding can be detected. Therefore, for alignment of the laser machining head and sensor device, it is beneficial to determine the position of the joint site at or after the laser beam position before the actual welding process.

Comparing of the positions of the joint site in the respective measurement zones and determining of the laser beam position relative to the joint site can ensure precise alignment or positioning of the laser beam relative to the joint. In addition, the position of the coordinate system of the sensor device used for detection is adapted to the geometry of the workpiece or joint site.

The position of the laser beam and the position of the joint in the respective measurement zones can be determined using a programmable camera, for example a complementary metal oxide semiconductor (CMOS) camera, mounted on the laser machining head to allow detection of three separate measurement zones on a single camera chip. The three separate measurement zones include a first measurement zone (which can be referred to as a pre-process window) in which the (lateral) position of the joint is detected ahead of the laser beam or weld point. In a second measurement zone (which can be referred to as an in-process window), the position of the laser beam focus on the workpiece surface is detected during the laser welding process. In some implementations, the (lateral) position of the joint is also detected in the second measurement zone before the laser welding process. In a third measurement zone (which can be referred to as a post-process window), in preparation for the laser welding, the position of the joint is detected after the laser beam, and during the laser welding process parameters of the welding seam upper bead are detected, for example convex or concave curvature and seam width. In addition, as discussed below, the distance of the laser machining head from the surface of the workpiece can be determined.

In one implementation, during detection of the joint position, the laser machining head and the workpiece are moved relative to each other along the joint. In this implementation, the path to be welded can be tracked once completely for calibration, whereby the joint is detected ahead of the laser beam position, and the position of the laser machining head and/or machining optical system arranged therein is adjusted with a time delay according to the measured position of the joint. In addition, the joint is detected at the laser beam position and any deviations from a nominal position of the joint are determined. This can compensate for track errors during the laser welding process that can occur when guiding the laser weld head along the joint seam. In some implementations, the laser weld head can be guided by a robotic arm and the track errors can be caused by, for example, to gearing errors of the movement axes of the robot arm. Deviations determined when tracking the path before the welding process are stored and used during the laser welding process to compensate for track errors. Compensation for track errors based on the stored deviations is feasible because, on repeated movement along the track to be welded, the robot arm always generates the same deviations. Additionally, tracking of the path to be welded allows adaptation of the measurement zones of the sensor device to the position of the joint, as discussed below.

In some implementations, the position of the joint in the respective measurement zone is determined using measurement light. In particular, a light section method with at least one light line can be used to determine the position of the joint. In the light section method, in each measurement zone one light line (such as a laser line) or a multiplicity of parallel light lines is projected at an angle onto the workpiece and can be detected by the camera. The light lines run substantially transverse to the joint. In the area of the joint site, therefore, the light line is broken or shifts occur that are detected by the camera or an analysis device connected therewith so that the position of the joint can be detected.

Alternatively, the position of the joint can be detected using the incident light method as certain joint geometries, for example, a butt joint without edge offset, generally cannot be detected by the light section method. In the incident light method, a broad region of a surface of the workpiece is illuminated from above. A change of brightness occurs at the joint site that is detected by the camera or an analysis device connected therewith so that the lateral position of the joint site can be detected.

In some implementations, the incident light and the light section methods can be used in combination. For example, the lateral position of the joint site can be determined with the incident light method and the distance between the welding lens and the workpiece surface with the light section method.

In some implementations, in a preceding step, the alignment of the laser machining head to the workpiece is determined using the alignment of the light lines in the measurement zones, and preferably a parallel alignment of light lines in the measurement zones is set. An absence of parallelism between the light lines of two measurement zones shows a deviation from the perpendicular alignment of the laser machining head to the workpiece surface. The deviation from the perpendicular alignment can be compensated by a swivel movement of the welding optical system about a tool center point (TCP) of the laser tool.

In some implementations, the distance of the laser machining head from the workpiece is determined using the position of two parallel light lines in the measurement zones, and the distance of the laser machining head is set to a nominal distance. For example, the laser machining head can be moved in a direction perpendicular to the workpiece until the light lines are positioned centrally in both measurement zones, which by definition indicates the correct working distance of the laser machining head from the workpiece surface.

In some implementations, to detect the laser beam position, a test point is generated with the high power laser beam on the workpiece, and the coordinate system of the sensor device is adapted to the laser beam position thus determined. To do this, either the sensor device or the measurement zones on the sensor surface are shifted in parallel until the test point and hence the laser beam position is detected centrally in the second measurement zone. To generate the test point, the laser beam is briefly ignited and the light phenomenon occurring is detected in the second measurement zone. The light detected corresponds to the position of the laser focus area on the workpiece. Then all measurement zones are shifted in parallel sufficiently far in one direction on the camera chip until the laser beam is detected centrally in the second measurement zone. Such a calibration step prevents constantly welding next to the joint site detected in the first measurement zone.

In some implementations, to adapt the sensor coordinate system to the course of the joint site, the measurement zones are moved relative to each other and point symmetrically to the laser beam position until the joint site is positioned centrally in the measurement zones concerned. In this calibration step, it is checked whether the detected position of the joint site is positioned centrally in the measurement zones. If this is not the case, the laser machining head can be turned about an axis running perpendicular to the workpiece in order to achieve the central positioning. A subsequent high precision adaptation is then achieved by shifting the measurement zones on the camera chip, as it is easier to compensate for deviations in the range of around 1/100 mm by adaptation of the sensors than by alignment of the laser machining head. Thus the measurement coordinate system is adapted to the workpiece geometry.

In a further implementation of the invention, the techniques for preparation of a laser welding process on a workpiece discussed above are used prior to a laser welding process on the workpiece. Preparation of the laser welding process using the techniques discussed above can result in a highly accurate seam position control and compensation of drift movements of the laser beam in the machining optical system.

In some implementations, during the laser welding process the laser machining head is moved along the joint by a guide device, such as a robot arm or a Cartesian-type handling system. A Cartesian-type handling system is an actuation system having a motion that is described in terms of Cartesian coordinates. It will be understood that apart from linear motions, a robot arm or a Cartesian-type handling system may also perform rotational motions, for example in a six axis system (having three linear axes and three rotational axes). A deviation of the position of the joint site from a nominal position, determined during preparation for the laser welding process in the second measurement zone, is taken into account when determining the optimum weld position in order to compensate for a track error in the guide device. In robot welding, the laser machining head is fitted to a robot or other Cartesian-type handling system that moves the laser machining head along the joint. The course of the track to be welded can be stored in a control device. In addition, the laser machining head is positioned above and perpendicular to the joint at the correct distance at certain points of the workpiece, and these positions are also stored in the robot control unit in order to bring the specified track course into alignment with the actual workpiece. The stored positions can be used to determine a learned track. During the welding process, the robot travels along the “learned” track while the seam position sensor detects the precise position of the joint and adjusts the position of the laser machining head via a positioning axis connected to the laser machining head. The actual track movement of the robot however does not, because of, for example, gearing errors in the robot movement axes, absolutely follow the specified track. For example, because of gearing errors, the robot follows the track within a tolerance of a few hundreds of a millimeter.

To compensate for these errors, after calibration of the measurement system, the track to be welded is first scanned completely, and the position of the joint in the first measurement zone detected via camera detection of a light line. The positioning axis of the machining head and/or machining optical system arranged therein is adjusted with a delay, according to the position measured. In a second measurement zone, via a second light line, the position of the joint is checked at the actual weld point (e.g., at the laser focus position). The deviations determined are stored, and are used in the subsequent weld process to compensate for the track error caused by the robot. Storing the determined deviations allows compensation for the track error because, on repeated movement, the robot always shows the same deviations from the “learned” track.

Further features and advantages of the techniques discussed above ensue from the following description of examples, from the figures, and from the claims. The techniques can be implemented as a method, process, device, apparatus, or computer software that includes instructions stored on a computer-readable medium. The individual features can be put into effect in a variant of the techniques discussed either individually, or in a plurality of any kind of combination.

### BRIEF DESCRIPTION OF THE DRAWINGS

FIG. 1 is a side cross sectional view of one implementation of a laser machining head and a sensor device for processing of a workpiece.

FIGS. 2a, 2b are surface views of the sensor device of FIG. 1 showing three measurement zones.

FIGS. 3a, 3b are surface views of the sensor device of FIG. 1 showing the three measurement zones moved by a parallel shift.

FIGS. 4a, 4b are surface views of the sensor device of FIG. 1 showing the three measurement zones with a joint site of a workpiece arranged in first and third measurement zones.

FIG. 5 is a side view of a rotationally symmetrically workpiece with a positioning error in the axial direction.

FIG. 6 is a surface view of the sensor device of FIG. 1 showing a representation of the three measurement zones.

FIG. 7a is a surface view of the sensor device of FIG. 1 showing a representation of the three measurement zones and a seam position adjustment without drift movement of the laser beam.

FIG. 7b is a surface view of the sensor device of FIG. 1 showing a representation of the three measurement zones and the seam position adjustment with drift movement of the laser beam and without drift compensation.

FIG. 7c is a surface view of the sensor device of FIG. 1 showing a representation of the three measurement zones and an example of the seam position adjustment with drift compensation.

FIG. 8 is a block circuit diagram of a control device to control a laser weld process of the laser machining head and sensor device of FIG. 1.

### DETAILED DESCRIPTION

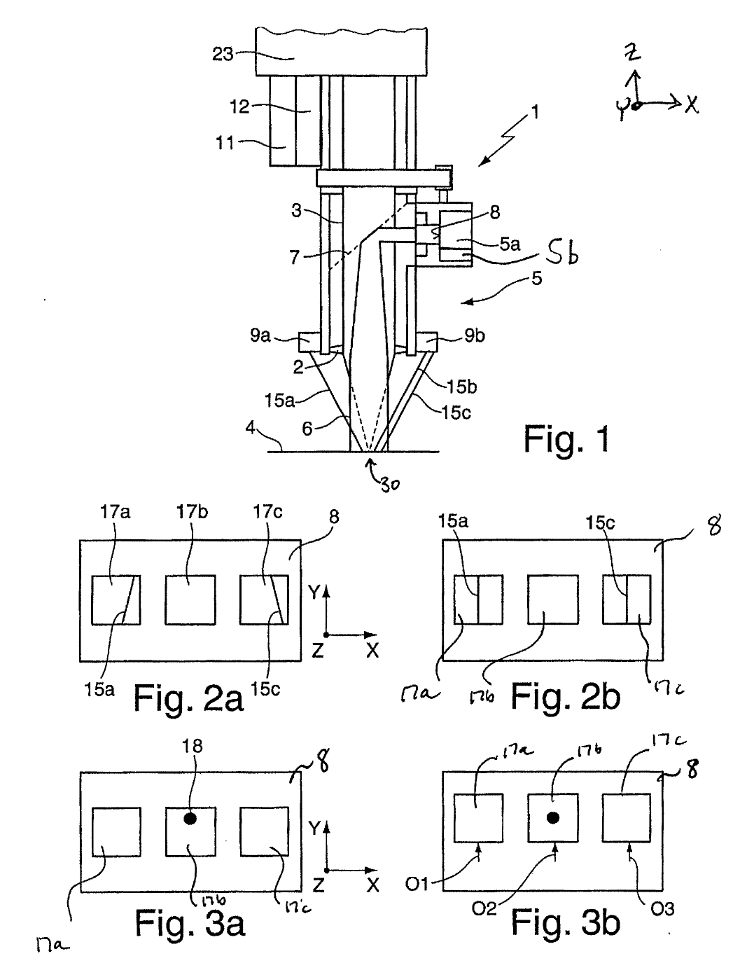

Referring to FIG. 1, a laser machining head 1 having a focusing lens 2 is shown. The lens 2 focuses a laser beam 3 that is guided to the laser machining head 1 onto a focus area (not shown) on a workpiece 4. A laser welding of the workpiece 4 occurs at the focus area. To monitor a welding area on the workpiece 4, a sensor device 5 that includes a sensor 5a, such as a complementary metal oxide semiconductor (CMOS) camera, is fitted to the laser machining head 1. The welding area and the focusing area are not necessarily the same area. For example, the welding area can be larger than the focus area.

The CMOS camera 5a has a beam path 6 that is bent at a partly transmissive deflection mirror 7 and deflected by the deflection mirror 7 onto a sensor surface 8 of the CMOS camera 5a. The focus area of the laser beam 3 is imaged on the sensor surface 8 of the CMOS camera 5a. Additionally, a larger section 30 of the workpiece 4 in the vicinity of the focus area of the laser beam 3 is imaged onto the sensor surface 8. The sensor device 5 also includes two line projectors 9a, 9b that project three laser lines 15a to 15c into the beam path 6 that is monitored by the CMOS camera 5a. Depending on the data detected by the CMOS camera 5a, the laser machining head 1 can be shifted along a first positioning axis (Y direction as shown in FIG. 1) by an actuator 11. The first positioning axis is a linear axis, and the actuator 11 is moved along the first positioning axis in order to move the laser beam 3 to an optimum weld position as discussed below. The laser machining head 1 can also be moved along a second positioning axis (Z direction as shown in FIG. 1) by an actuator 12. Moving the laser machining head 1 along the second positioning axis with the actuator 12 varies the distance between the laser machining head 1 and the workpiece 4.

Referring to FIG. 2a, three measurement zones 17a to 17c are formed at the sensor surface 8 of the CMOS camera 5a. The three measurement zones 17a to 17c are first arranged in succession in a line along an X direction as shown in FIG. 2a. The first measurement zone 17a (which can be referred to as a pre-process measurement window) detects a section of the workpiece 4 that is ahead of the laser beam 3 during the welding process. Thus, the first measurement zone 17a detects a section of the workpiece 4 that has not yet been welded by the laser beam 3. The second measurement zone 17b (which can be referred to as an in-process measurement window) detects the immediate weld region with the focus area of the laser beam 3, and the third measurement zone 17c (which can be referred to as a post-process measurement window) detects a section of the workpiece 4 following the welding. The three measurement zones 17a to 17c correspond to the areas in which the intensity of the light irradiated onto the sensor surface 8 is evaluated by an analysis device 5b which is part of the sensor device 5 or may be arranged in a control computer at a remote location. The analysis device 5b includes a processor and memory for performing the evaluation. In the example shown in FIG. 2a, the measurement zones 17a to 17c are square in shape; however, in other examples the measurement zones 17a to 17c can be other shapes. For example, the measurement zones 17a to 17b can be rectangular, polygonal, elliptical, or circular. The measurement zones 17a to 17c can all have the same shape or can have distinct shapes from each other.

The sensor device 5 that includes the camera 5a, the analysis device, and the line projectors 9a, 9b, is calibrated automatically before the welding process by analyzing the measurement values detected in the three measurement zones 17a to 17c in combination. For the calibration, in a first step the alignment of the laser machining head 1 is set. As shown in FIG. 2a, the first and third light lines 15a, 15c of the line projectors 9a, 9b are detected in the first and third measurement zones 17a and 17c. In the example shown in FIG. 2a, the two light lines 15a, 15c are not aligned parallel to each other, which indicates a deviation between the perpendicular alignment of the laser machining head 1 to the surface of the workpiece. This misalignment is corrected by an angle adjustment of the welding optical system by a swivel movement of the welding optical system or laser machining head 1 about the tool center point (TCP). After the swivel movement, the two light lines 15a, 15c are aligned parallel to each other as shown in FIG. 2b.

After calibration of the alignment of the laser machining head 1, the working distance of the laser machining head 1 perpendicular to the surface (in the Z direction) of workpiece 4 is set.

The laser machining head 1 is moved in the Z direction until the parallel aligned light lines 15a, 15c are positioned centrally in the X direction of the measurement zones 17a, 17c. The distance of the first measurement zone 17a from the third measurement zone 17c was selected such that the centrally positioned light lines 15a, 15c by definition indicate the correct working distance (nominal distance) of the laser machining head 1 from the surface of the workpiece 4. Adjustment of the working distance in the manner described above is advantageous in particular when welding radial seams on rotationally symmetrical workpieces, as here it can be ensured that the laser machining head 1 at the position of the laser beam 3 has the correct distance from and correct alignment to the workpiece 4.

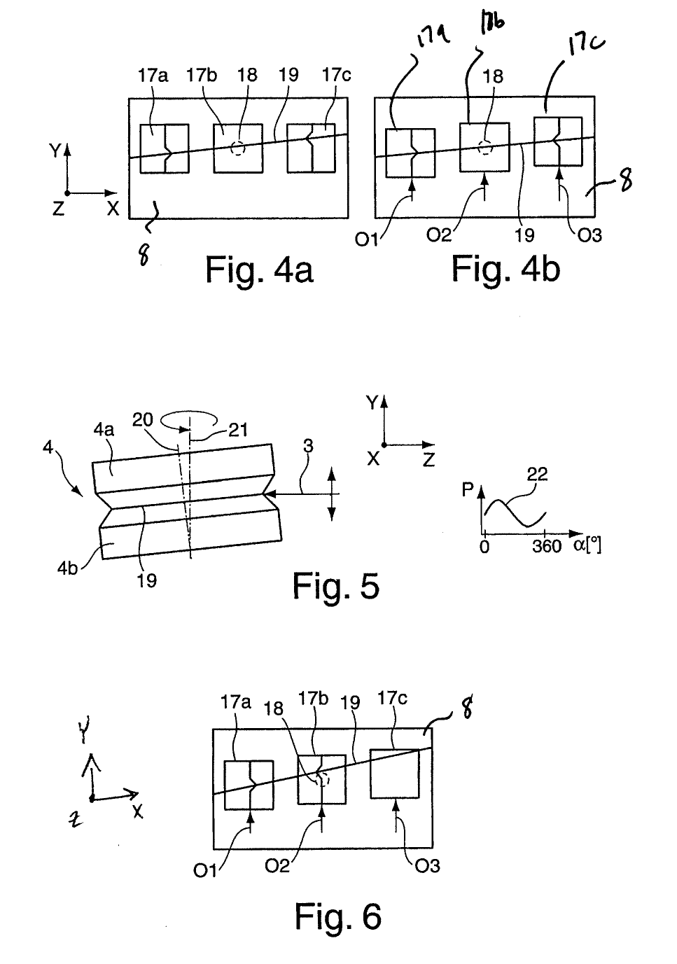

Referring to FIGS. 3a and 3b, a representation of the three measurement zones 17a to 17c is shown. After alignment and adjustment of the working distance of the laser machining head 1, the position of the laser beam 3 is checked. To check the position of the laser beam 3, a test point is set on the workpiece 4 with the laser beam 3 set to the same power as in the later welding process. The focus area generated corresponds to the laser beam position 18, the light phenomenon of which is detected in the second measurement zone 17b of camera 5a as shown in FIG. 3a. After the laser beam position 18 is detected in the second measurement zone 17b, all of the measurement zones 17a to 17c are shifted parallel in the Y direction sufficiently far on the sensor surface 8 for the laser beam 3 to lie centrally (in the Y direction) in the second measurement zone 17b. The example shown in FIG. 3b shows the measurement zones 17a to 17c after shifting the measurement zones 17a to 17c. Sensor offsets O1 to O3 are generated in the present case in the Y direction for each of the three measurements zones 17a to 17c. The sensor offsets O1 to O3 represent the distance that the measurement zones 17a to 17c were shifted in the Y direction to bring the laser beam position 18 to the center of the second measurement zone 17b. The offsets O1 to O3 can be for example, 0.050 mm. The calibration step described above adjusts the laser beam position 18 to prevent constantly welding next to a joint site on the workpiece 4, rather than at the joint site. The angular position of the measurement zones 17a to 17c is subsequently checked and adjusted as discussed below and shown in FIGS. 4a and 4b.

Referring to FIGS. 4a and 4b, the three measurement zones 17a to 17c are shown. In the example of FIGS. 4a and 4b, a joint site 19 runs centrally through the second measurement zone 17b so that the position of the joint site 19 in the second measurement zone 17b corresponds with the laser beam position 18. The central positioning of the joint site 19 can be achieved, for example, by determining the position of the joint site 19 in the second measurement zone 17b by the second light line 15b. To position the joint site 19, the workpiece 4 and machining head 1 are shifted parallel to each other until the joint site 19 lies centrally in the second measurement zone 17b. The measurement zones 17a to 17c can be shifted relative to the surface of the sensor 8 using software implemented in the sensor 8 that, for example, can control the sensor 8 and be used to acquire and manage data sensed by the sensor 8. In some implementations, the measurement zones 17a to 17c can be shifted by moving the sensor 8 itself.

In a subsequent step, whether the joint site 19 is also positioned centrally in the first and third measurement zones 17a, 17c is determined. If the joint site 19 is not centrally positioned in the first and third measurement zones 17a and 17c, the laser machining head 1 can be rotated about a rotational axis running perpendicular to a surface of the workpiece 4 in order to achieve central positioning. A subsequent adaptation is then achieved by shifting the measurement zones 17a to 17c on the sensor surface 8 of the camera chip relative to each other such that the measurement zones 17a to 17c point symmetrically to the laser beam position or the center point of the second measurement zone 17b. The adaptation is performed by shifting the measurement zones 17a to 17c on the sensor surface 8 because it is usually easier to compensate for deviations in the range of a few hundreds of a millimeter (up to approx. 1/10 mm) by adapting the sensor 5 rather than by positioning the laser machining head 1. In the example shown in FIGS. 4a and 4b, the offset O1 of the first measurement zone 17a is reduced by 0.025 mm to 0.025 mm relative to the second measurement zone 17b, and the offset O3 of the third measurement zone 17c is increased by 0.025 mm to 0.075 mm. Thus, the coordinate system of the sensor 5 is adapted to the geometry of the workpiece.

Referring to FIG. 5, a rotationally symmetrical workpiece welded with a laser is shown. In the example shown in FIG. 5, the rotationally symmetrical workpiece is a tube. The angular alignment described above can be used, for example, when welding a radial seam on the rotationally symmetrical workpiece 4. The workpiece 4 shown in FIG. 5 has, in the direction of its symmetry axis 20, two workpiece parts 4a, 4b that lie next to each other along the joint 19. To perform the laser welding process, the workpiece 4 is turned about a rotation axis 21, which runs in an axial direction (Y direction). Perpendicular to the axial direction (Y direction) and perpendicular to the image plane is an X direction along which run the three measurement zones 17a to 17c discussed above with respect to FIGS. 4a and 4b. The laser beam 3 in the example shown in FIG. 5 runs in a direction Z in the image plane perpendicular to the axial direction (Y).

As shown in the example of FIG. 5, the rotation axis 21 and symmetry axis 20 of the rotationally symmetrical workpiece 4, because of the incorrect positioning in clamping, do not coincide. On rotation of the workpiece 4 about the rotation axis 21, the incorrect positioning leads to a tumbling motion so that the position of the joint 19 changes in both the axial direction Y and in the lateral direction X. The resulting positioning error can be described by three error types, one of which is run-out. Run-out error represents the deviation of the joint site 19 from an ideal weld position in the axial direction (Y direction).

In a complete revolution of the workpiece 4 about the rotation axis 21, the run-out shows a sine-wave course 22 of position P in the Y direction as a function of rotation angle α, the period length of which corresponds to one revolution (360°). In calibration, a measurement run over the workpiece revolution (360°) in the first and third measurement zones 17a, 17c allows continuous detection of the position of the joint 19 and the lateral offset of the sine-wave courses can be calculated from the measurement in the first measurement window 17a and the measurement in the third measurement window 17c, where the respective sine offset corresponds to the mean of the sine-wave course in the respective measurement window 17a, 17c.

From this result, the first and third measurement zones 17a, 17c are shifted accordingly in mutually opposing directions on the sensor surface 8, where the result of the shift of all three measurement zones 17a to 17c (pre-offset_equidistant of 0.050 mm) is included. For example, as discussed above with respect to FIGS. 4a and 4, before adjusting the positioning of the joint site, the three measurement zones 17a to 17c each have an offset of 0.050 mm. In the above example, for the first measurement zone 17a a first offset O1 (pre-offset_total)=pre-offset_equidistant+(pre-sine offset−post-sine offset)/2=0.025 mm is calculated, and for the third measurement zone 17c the third offset O3 (post-offset_total)=post-offset_equidistant−(pre-sine offset−post-sine offset)/2=0.075 mm, where pre- and post-offset designate the respective offset of the first measurement zone 17a (pre-measurement window) and the third measurement zone 17c (post-measurement window).

The alignment described above of measurement zones 17a to 17c can be used not only on joint sites with a path running linearly through the three measurement zones 17a to 17c, but also on joint sites with other path forms, such as circle sections that occur in axial welding of rotationally symmetrical workpieces. In such axial weld seams, a second light line 15b in the second area of measurement 17b is used for automatic calibration as the track in the form of a circle section can be described by three lateral measurement points (pre-process, in-process and post-process in the Y direction). The calibration steps described above, such as the parallel shift of the three measurement zones 17a to 17c and their shift relative to each other, is performed similarly in this case. Alternatively or additionally to detecting the position of joint 19 using light lines, the position of the joint 19 can be detected by an incident light method. In the incident light method, a broad region of a surface of the workpiece 4 is illuminated from above. A change of brightness occurs at the joint site 19, and the change in brightness is detected by the CMOS camera 5a so that the lateral position of the joint site can be detected. In some implementations, the incident light and the light section methods can be used in combination. For example, the lateral position of the joint site 19 can be determined with the incident light method and the distance between the laser welding head 1 and the surface of the workpiece 4 can be determined with the light section method.

The calibration method described above, which can be performed automatically, can ensure the precise alignment of the laser machining head 1 to the workpiece 4 by detecting the position of the joint site 19 in at least two measurement zones and by detecting the laser beam position 18. A correct alignment of the measurement zones 17a to 17c on the sensor surface 8 in relation to the laser beam 3 can be ensured so that the position of the weld seam in the joint site 19 of the workpiece 4 is correct, and complex adjustment of the sensor based on ground sections or engraving may not be required. Also, the correct function of the sensors in series use can be automatically checked, documented and if necessary re-calibrated with this method after the end of a defined batch size.

Furthermore, in a welding process in which the laser machining head 1 is attached to a robot arm 23 (as shown in FIG. 1), or a comparable guide device, and moved by this device during the weld process along the joint, a further calibration step can occur between the calibration described above of the measurement system and the actual weld process.

For welding using robots, the path of the track to be welded is stored in the robot control unit. Then the laser machining head 1 is positioned at certain points of the workpiece above and perpendicular to the joint at the correct distance, and these positions are also stored (learned) in the robot control unit in order to bring the specified track course into alignment with the actual workpiece. The path determined by the stored positions can be referred to as a learned path. During the welding process, the robot follows the “learned” path while the sensor device 5 detects the precise position of the joint 19 and adjusts the position of the laser head 1 via the actuator 11 as described below.

The actual track movement of the robot does not however, because of gearing errors of the robot movement axes, follow the specified track absolutely. Rather, the track movement of the robot can be within a tolerance of the specified track in the range of a few hundreds of millimeters. To adjust for these errors, after calibration of the measurement system, the track to be welded is scanned once completely along the joint site 19. Referring to FIG. 6, the position of the joint site 19 in the first measurement zone 17a is detected via the first light line 15a, and the actuator 11 is adjusted along the positioning axis so that the laser machining head 1 is adjusted with a delay according to the position measured. In the second measurement zone 17b, via the second light line 15b the position of the joint site 19 is checked at the actual laser beam position. The deviations determined from the nominal position of the joint 19 to the center of the measurement zone 17b are stored and used in the subsequent welding process to compensate for the track error caused by the robot. This is possible because the robot, or any other guide or movement device, on repeated movement always shows the same deviation from the “learned” path.

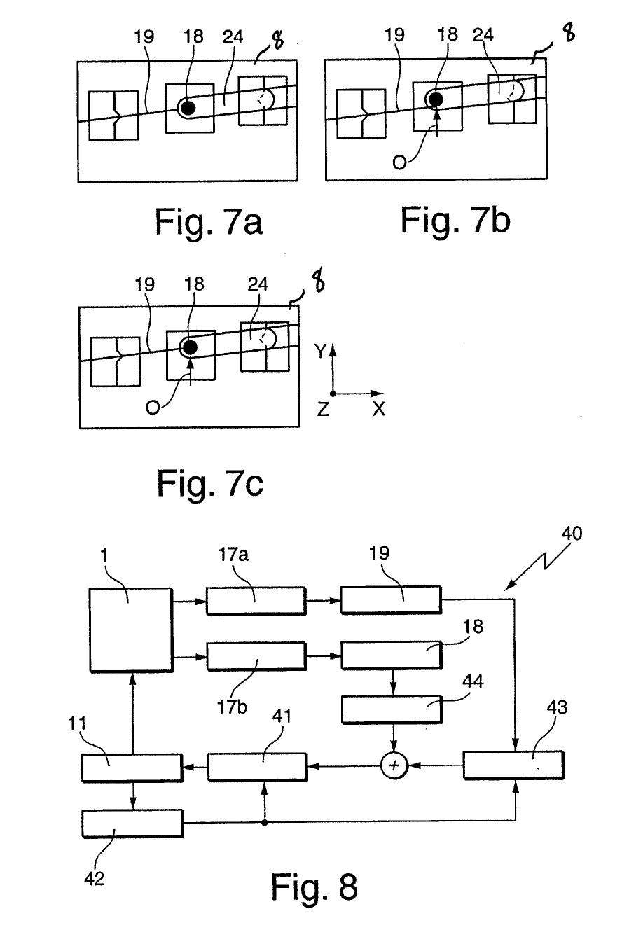

Referring to FIGS. 7a to 7c, seam position adjustment during laser welding is shown. In performance of the laser welding process shown in FIGS. 7a to 7c, the laser beam 3 is operated at high power and moved in a weld direction (in the example shown, the weld direction is the negative X direction) relative to the workpiece 4. A laser beam focus is formed at the laser beam position 18 and generates a weld point on the workpiece 4, and a weld seam 24 is formed behind the weld point. Because the laser beam focus is positioned at the laser beam position 18 during welding, the two terms “laser beam focus” and “laser beam position” are used interchangably below.

On a relative movement between workpiece 4 and laser machining head 1, either the workpiece 4 remains stationary, in which case the laser machining head 1 is moved in the weld direction as is the case for robot welding, or the laser machining head 1 remains stationary and the workpiece 4 is moved along the welding direction. When welding radial seams (such as the example shown in FIG. 5), the workpiece 4 is usually moved along the welding direction while the laser machining head 1 remains stationary. In some implementations, superimposed movement of laser machining head 1 and workpiece 4 can also occur. In these implementations, the relative movement between the laser machining head 1 and the workpiece 4 occurs because both the laser machining head 1 and the workpiece 4 move.

During the relative movement, the actual laser beam position 18 in the optical system or at the surface of the workpiece 4 is continuously detected and analyzed during laser welding in the second measurement zone 17b. The actual laser beam position is a parameter that is superimposed to the conventional control loop of seam position control, which is discussed below. To do this during welding, the laser beam position 18 actually detected in the second measurement zone 17b is compared with the position of the joint 19 previously determined in the first measurement zone 17a and stored, for example, in the analysis device 5a. If the laser beam 3 does not perform a drift movement, the laser beam position 18 is always in the center of the second measurement zone 17b, as shown in FIG. 7a. However, if the laser beam position 18 changes in the second measurement zone 17b, for example, because of temperature-induced drift movements, the laser beam position 18 has an offset O. Thus, the laser beam position 18 in the Y direction deviates from the position of the joint 19 in the direction of the offset O, and the weld seam 24 is offset relative to the joint 19. The deviation leads to a welding error, as shown in FIG. 7b.

However, a compensation for drift movements of the laser beam 3 can be made in the machining optical system: When a deviation of the laser beam position 18 from the central position is found, the position of the laser machining head 1 can be adjusted via the actuator 11 so that, as shown FIG. 7c, the position of the joint 19 site is moved relative to the laser beam position 18, such that the joint site 19 and the weld seam 24 again run along a common line. As a result, a correct weld can be ensured.

In some implementations, in addition to positioning the laser focus area as precisely as possible in the center of the joint 19, also a positioning can be set with a specified constant offset of the laser beam relative to the joint site 19 if required for machining. In this case, taking into account seam position detection in the first measurement zone and drift compensation of the laser beam in the second measurement zone, a further offset dimension is added to the result of the track planning or extended position control loop.

Referring to FIG. 8, a simplified diagram of a control loop 40 for the expanded seam position control described above with drift compensation of the laser focus area is shown. The control loop 40 includes a controller 41 that adjusts the laser machining head 1 along the correction axis. As discussed with respect to FIG. 1, a device 11 acting along the correction axis (the Y direction of FIG. 1) moves the laser machining head 1 in the Y direction to avoid incorrect welding. A measurement system 42 includes an incremental sensor that detects position. The measurement system 42 determines the actual position of the device 11 that moves the laser machining head 1 along the correction axis (which indicates the position of the laser machining head 1) and passes the position to a track planning unit 43. The track planning unit 43 calculates, from the actual position, a nominal position of the device 11 along the correction axis and sends the nominal position to the controller 41. Based on the deviation between the nominal and actual position, the controller 41 adjusts the position of the device 11 that moves the laser machining head 1 along the correction axis.

The laser welding optical system of the laser machining head 1 in which the sensor device 5 is integrated sends to the track planning unit 43 the position of the joint site 19 detected in the first measurement zone 17a in the lateral direction (Y direction), in order to take this position into account in calculating the nominal value for the position of the actuator 11 along the correction axis. The lateral laser beam position 18 measured in the second measurement zone 17b (corresponding to the laser focus area) which was detected from image analysis, is first supplied to a filter 44 and the filter values are superimposed to the nominal position of the actuator 11 along the correction axis of the control loop 40. Thus, lateral drift movements of the laser beam are automatically compensated. Also a system-induced offset of the laser beam in the optical system, for example due to a change of optical fiber at the laser machining head, is compensated automatically.

Altogether, in the manner described above, laser welding is possible with high precision seam position control on the joint site to be welded with compensation for drift movements of the laser beam 3 in the machining optical system. Track errors that can occur on movement of the laser machining head 1 along the workpiece 4 can be compensated.

The foregoing description is intended to illustrate and not limit the scope of the techniques discussed above. Other aspects, advantages, and modifications are within the scope of the following claims.

What is claimed is:

1. A method for preparing for laser welding of a workpiece, the method comprising:
detecting, with a sensor device, a first position of a joint site on a workpiece, the first position being in a first measurement zone in front of a position of a laser beam incident on the workpiece;
detecting, with the sensor device, one or more of a second position and a third position of the joint site, the second position being in a second measurement zone at the position of the laser beam incident on the workpiece, the third position being in a third measurement zone behind the position of the laser beam incident on the workpiece;
detecting, with the sensor device, the position of the laser beam incident on the workpiece;
comparing the first, and one or more of the second and third positions of the joint site to the position of the laser beam; and
adjusting, based on the comparison, one or more of a laser machining head configured to direct the laser beam onto the workpiece and the sensor device relative to the workpiece.

2. The method of claim 1, wherein the laser machining head is adjusted, and adjusting the laser machining head comprises one or more of adjusting a position and alignment of the laser machining head relative to the workpiece.

3. The method of claim 1, wherein the sensor device is adjusted, and adjusting the sensor device comprises one or more of adjusting a position, alignment, and coordinate system of the sensor device.

4. The method of claim 1, wherein adjusting one or more of a laser machining head and the sensor device comprises, while detecting the positions of the joint site on the workpiece, moving the laser machining head and the workpiece relative to each other along the joint site.

5. The method of claim 1 further comprising:
projecting at least one light line into a measurement zone on the workpiece;
detecting, with the sensor device, a reflection of the at least one light line, and wherein detecting, with the sensor device, the first, second and the third positions of the joint site comprises using the detected reflection.

6. The method of claim 5, wherein projecting at least one light line onto the workpiece comprises projecting two or more light lines onto the workpiece, and further comprising:
determining an alignment of the light lines in the first and third measurement zones;
aligning the laser machining head with the workpiece based on the alignment of the light lines in the first and third measurement zones.

7. The method of claim 6, wherein determining an alignment of the light lines in the first and third measurement zones comprises determining whether the light lines in the first and third measurement zones are parallel to each other.

8. The method of claim 7, wherein the light lines are parallel to each other, and further comprising:
determining a distance of the laser machining head from the workpiece from the position of two parallel aligned light lines in the first and third measurement zones; and
setting the distance of the laser machining head from the workpiece to a nominal distance.

9. The method of claim 1, wherein detecting the position of the laser beam incident on the workpiece comprises detecting a position of a test point marked on the workpiece by the laser beam and further comprising adapting the coordinate system of the sensor device to the detected position of the test point.

10. The method of claim 9, wherein adapting the coordinate system of the sensor device comprises shifting the sensor device or the measurement zones until the position of the test point is at a nominal position.

11. The method of claim 10, wherein the nominal position is a center of the second measurement zone.

12. The method of claim 1, further comprising adapting a coordinate system of the sensor device to a course of the joint site by moving the first and third measurement zones relative to each other.

13. The method of claim 12, wherein the position of the laser beam is in the center of the second measurement zone, and the first and third measurement zones are moved until the joint site is positioned centrally in the first and third measurement zones.

14. A method for performing laser welding on a workpiece, the method comprising:
detecting, with a sensor device prior to laser welding, a first position of a joint site on a workpiece, the first position being in a first measurement zone in front of a position of a laser beam incident on the workpiece;
detecting, with the sensor device prior to laser welding, one or more of a second position and a third position of the joint site, the second position being in a second measurement zone at the position of the laser beam incident on the workpiece, the third position being in a third measurement zone behind the position of the laser beam incident on the workpiece;
detecting, with the sensor device prior to laser welding, the position of the laser beam incident on the workpiece;
comparing the first, and one or more of the second and third positions of the joint site to the position of the laser beam;
adjusting, prior to laser welding and based on the comparison, one or more of a laser machining head configured to direct the laser beam onto the workpiece and the sensor device relative to the workpiece;
detecting, during laser welding, a position of a joint site on the workpiece in a first measurement zone in front of a position of the laser beam;
detecting, during laser welding, the position of the laser beam in a second measurement zone at a focus area of the laser beam;
determining an optimum weld position by comparing the detected position of the laser beam and the detected position of the joint site; and
moving the laser machining head to the optimum weld position.

15. The method of claim 14, wherein the laser machining head is moved along the joint site by a guide device.

16. The method of claim 14 further comprising determining, prior to the laser welding of the workpiece, a deviation of the position of the joint site in a second measurement zone at the position of the laser beam from the position of the laser beam, and wherein determining the optimal weld position comprises compensating for the deviation.

17. An apparatus for laser welding, the apparatus comprising:
a laser machining head configured to direct a laser beam onto a workpiece;
a lens to focus the laser beam onto the workpiece such that the workpiece is welded at a focus area of the laser beam;
a sensor device comprising a sensor configured to image a first measurement zone in front of the focus area, a second measurement zone at the focus area, and a third measurement zone behind the focus area; and
an analysis device configured to:
determine a first position of a joint site on the workpiece in the first measurement zone and a second position of the joint site in the second measurement zone, and a third position of the joint site in the third measurement zone;
determine a position of the focus area of the laser beam,
compare the first, second and third positions of the joint site and the position of the focus area of the laser beam, and
adjust one or more of the laser machining head and the sensor device relative to the workpiece based on the comparison.

18. The apparatus of claim 17 further comprising at least one light projector configured to direct a light line onto the workpiece.

19. The apparatus of claim 17 further comprising a deflection mirror configured to deflect radiation from the workpiece onto the sensor.

20. The apparatus of claim 17, wherein the sensor comprises a CMOS camera.

21. The apparatus of claim 17 further comprising a guide device coupled to the laser machining head, the guide device configured to move the laser machining head.

22. The apparatus of claim 21, wherein the guide device comprises a robotic arm.
